(19) United States
(12) Patent Application Publication
(10) Pub. No.: US 2015/0017404 A1
(43) Pub. Date: Jan. 15, 2015

(54) INJECTION-MOULDED DECORATIVE MOULDED ARTICLE WITH EFFECT PIGMENTS AND MANUFACTURING METHOD

(71) Applicants: Udo Gayer, Aidlingen (DE); Bernhard Klein, Neuburg a.d. Donau (DE); Malwina Lapinska, Echterdingen (DE); Holger Steeb, Tuebingen (DE)

(72) Inventors: Udo Gayer, Aidlingen (DE); Bernhard Klein, Neuburg a.d. Donau (DE); Malwina Lapinska, Echterdingen (DE); Holger Steeb, Tuebingen (DE)

(73) Assignee: DAIMLER AG, Stuttgart (DE)

(21) Appl. No.: 14/380,121

(22) PCT Filed: Dec. 22, 2012
(86) PCT No.: PCT/EP2012/005368

§ 371 Date: Aug. 21, 2014

(30) Foreign Application Priority Data
Feb. 22, 2012 (DE) 10 2012 003 375.3

(51) Int. Cl. B44F 7/00; B29C 45/00; B44C 3/04; B29C 45/14

(52) U.S. Cl. CPC B44F 7/00; B29C 45/1418; B29C 45/0013; B44C 3/04; B29C 2045/0079
USPC 428/207; 264/279; 264/161

(57) ABSTRACT

A decorative moulding and a method for the production thereof. The decorative moulded article has at least one injection-moulded main body made of thermoplastic material; with a deep 3D surface structure on a visible surface and a cover layer of transparent plastic applied at least to the visible surface. The main body has at least one layer on the visible surface, said layer containing platelet-shaped effect pigments and said platelet-shaped effect pigments being mainly oriented in parallel to the surface of the visible surface of the main body.

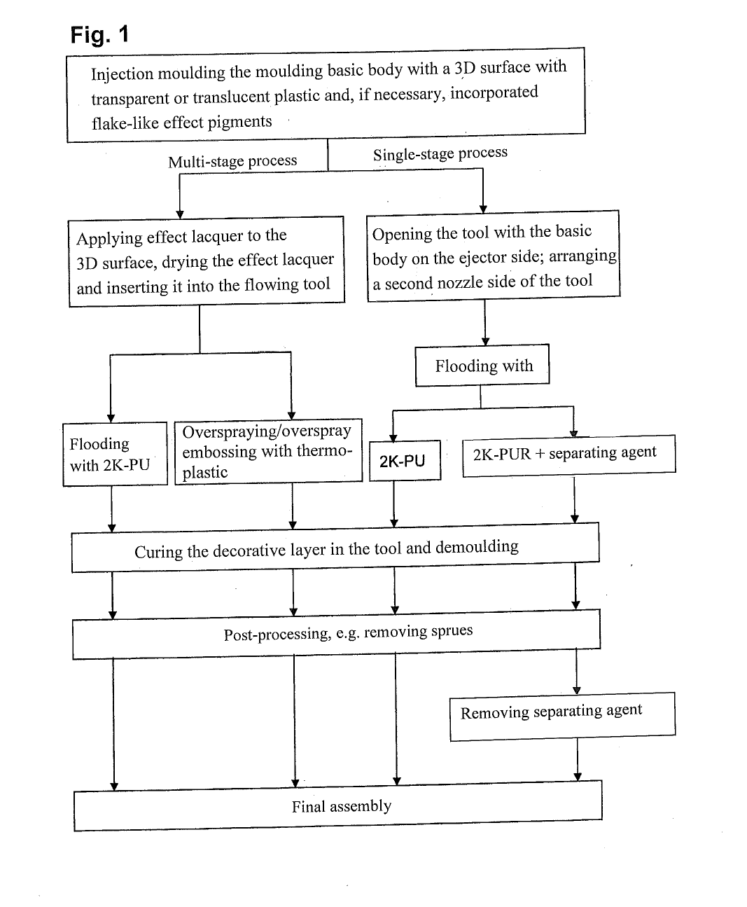

The invention relates to a decorative moulding, in particular for interior trim in a motor vehicle, as well as a method for the production thereof.

In automotive engineering, high-quality decorative parts and decoratively designed functional elements are used in the interior in order to give the vehicle an exclusive appearance. To that end, precious wood or metal is often used, but increasingly also plastics, which may be adjusted in a targeted manner to the function and design. In order to create a surface of the plastic part that has a corresponding high-quality appearance, it is known from the prior art to also create plastic parts from the fields of furniture and electronic devices, with a comprehensive matt or glossy surface. Furthermore, a so-called piano finish effect can be produced by the plastic parts being moulded in two successive injection moulding processes with two different material components. Also, the production of plastic parts with a three-dimensionally-operating surface is known, which is produced by back injection of relatively thick films.

To that end, DE 10 2010 031 814 A1 describes a moulding tool for moulded parts having a positive surface structure, as well as a method for the production of the moulding tool and for the production of the moulded part with the aid of the moulding tool. This is provided with a coating made from a topcoat for the protection of the decorative surface of the moulded part.

With clear coat moulding (CCM), an automated method that is suitable for this is known, in which high-quality components can be poured over very thinly with a clear, two-component PUR system.

DE 102010031814 A1 discloses a decorative moulding made from an injection moulded basic body having a 3D surface structure on the visible surface and a decorative layer made from transparent plastic applied to the visible surface.

DE 4218106 A1 discloses a coating agent that is based on specific methacrylic copolymers and may contain effect pigments, which is particularly suitable for base layers in multilayer coatings and solves the object of providing improved dissolution resistance during overcoating with clear lacquer.

DE 10253680 A1 describes multilayer composite structures that have a thermoplastic polymer layer with liquid crystal effect pigments, wherein the polymer layer with the liquid crystal effect pigments has a transparent polymerous UV protective layer in order to improve the thermal stability and light stability of the composite structure.

Based on this prior art, the object of the present invention is to create a decorative part that has a high-quality appearance and is resistant to ageing, having a surface structure with an improved 3D effect with reduced costs and production expenditure.

This object is solved by a decorative moulding part having the features of claim 1.

The object to produce such a decorative moulding is solved by the two alternative methods having the features of claims 7 and 9.

Developments of the decorative moulding and the methods are embodied in the dependent claims.

In a first embodiment of the decorative moulding according to the invention, which comprises at least one injection moulded basic body made from thermoplastic material having a deep 3D surface structure on a visible surface and a cover layer applied at least on the visible surface, made from transparent plastic, the basic body has at least one layer having flake-like effect pigments on the visible surface. These flake-like effect pigments are present with mainly parallel positioning with respect to the surface of the visible surface of the basic body. Thus a decorative moulding is provided which has a design that is innovative and has a high-quality appearance. The gloss effect is optimised by the flake-like effect pigments positioned parallel to the surface of the visible surface of the basic body. “With mainly parallel positioning” means here that the predominant proportion of the flake-like effect pigments is arranged parallel to the surface in order that the effect produced by the effect pigments be as impressive and extensive as possible and that the structure emphasise this surface provided as the visible surface of the decorative moulding.

Here, the plastic that forms the basic body containing the flake-like effect pigments, or the layer that contains the flake-like effect pigments, can be a supplementary polymer layer applied to the basic body that may, but not must, additionally contain flake-like effect pigments. “Supplementary polymer layer” can here mean a lacquer as well as another plastic layer.

The thermoplastic material of the basic body can be a transparent, translucent or opaque, coloured or colourless plastic. Furthermore, the polymerous material of the supplementary layer containing the flake-like effect pigments can correspond to the plastic of the basic body with respect to its optical properties; it can therefore be transparent, translucent or opaque and can be coloured or colourless according to the plastic of the basic body.

The decorative moulding can have a coloured or colourless transparent cover layer and can preferably consist of
at least one thermoplastic, comprising cellulose acetate (CA), methacrylic acid butadiene 1,3-styrene terpolymer (MABS), acrylic acid styrene acrylonitrile terpolymer (ASA), polycarbonate (PC), particularly preferably poly(methyl methacrylate) (PMMA), amorphous TPU, microcrystalline PA,
a 2K polyurethane system, preferably a 2K polyurethane system with integrated separating agents, made from oligoether polyols having 3 to 5 OH groups per molecule, preferably having 3 OH groups per molecule, preferably primary OH groups, low-molecular chain extenders, preferably from the group comprising ethanediol-1,2; bis-(1-hydroxyethyl)-ether; 2,3-propanediol, 1,4-butanediol; 1,6-hexanediol, 2,2′-dimethylpropanediol; isomer mixtures of trimethyl-1,6-hexanediol or 5-hydroxy-1-hydroxymethyl-1,3,3-trimethylcyclohexane (isophorone-diol), as well as oligomeric aliphatic and/or cycloaliphatic polyisocyanates having 2 to 6 NCO groups per molecule, preferably 3 to 4 NCO groups per molecule, or consisting of
   oligo ester polyols having 3 to 5 OH groups per molecule, preferably having 3 OH groups per molecule, preferably having primary OH groups, low-molecular chain extenders, preferably from the group comprising ethanediol-1,2; bis-(1-hydroxyethyl)-ether; 2,3-propanediol, 1,4-butanediol; 1,6-hexanediol, 2,2′-dimethyl 2,3-propanediol; isomer mixtures of trimethyl-1,6-hexanediol or 5-hydroxy-1-hydroxymethyl-1,3,3-trimethylcyclohexane, as well as oligomeric aliphatic and/or cycloaliphatic polyisocyanates having 2 to 6 NCO groups per molecule, or
a 2K polyurea system made from oligomeric polyamines, preferably oligo ether polyamines having 3 to 5 NHR′ groups per molecule, wherein R′ is preferably hydrogen, low-molecular amine chain extenders, preferably aliphatic or cycloaliphatic chain extenders from the group comprising ethylene diamine, propylene diamine, tetramethylene diamine, hexamethylene diamine, isomer mixtures of trimethyl hexane diamine-1,6, 5-amino-1-amino methyl-1,3,3-trimethylcyclohexane as well as oligomeric aliphatic and/or cycloaliphatic polyisocyanates having 2 to 6 NCO groups per molecule.

The basic body can be coloured opaque white, brightly coloured or pearlescent and the cover layer can be transparent black-grey, such that an impressive, tinted-glass-esque surface appearance of the visible surface of the decorative moulding is advantageously created.

The production of the decorative moulding can take place in two alternative ways.

In a first method for the production of a decorative moulding, the following steps are undertaken:
injection moulding the basic body from a thermoplastic material in a moulding tool, then forming a deep 3D surface structure on the visible surface provided,
applying an effect lacquer that is coloured according to the thermoplastic material, said lacquer containing flake-like effect pigments, then positioning the flake-like effect pigments predominantly parallel with respect to the surface of the visible surface of the basic body, and
drying the effect lacquer layer,
inserting the basic body with the applied effect lacquer into a flowing tool and applying a transparent plastic at least to the effect-lacquered visible side, then forming a decorative layer and curing the decorative layer,
demoulding the decorative mould.

Here, the application of the transparent plastic can take place by
flooding with a transparent 2K polyurea system, or
overspraying, preferably overspray embossing, with a transparent thermoplastic.

Furthermore, for the optimisation of the surface finish of the decorative moulding, it can be expedient to undertake a post-processing step after the demoulding of the decorative moulding, which comprises the removal of sprues.

After the demoulding of the decorative moulding, a final assembly stage can furthermore be implemented immediately or after the post-processing, in which the decorative moulding is assembled into a superior component, for example a framework.

The second alternative method for the production of the decorative moulding according to the invention comprises the steps:
injection moulding the basic body from a thermoplastic material in a moulding tool with tool halves on the ejector side and the nozzle side, then forming a deep 3D surface structure and positioning the flake-like effect pigments predominantly parallel with respect to a provided visible surface,
opening the moulding tool, wherein the basic body remains in the ejector-side tool half, and arranging this into a second nozzle-side tool half of the moulding tool, which has a cavity for the creation of the decorative layer on the basic body that has a surface added for the surface finish. What follows is:
flooding the visible surface with the surface structure of the basic body with a transparent plastic for the formation of a decorative layer and curing the decorative layer,
demoulding the decorative moulding.

For the high-gloss finish, the transfer of the injection-moulded part, for example by means of a slide table or turning plate, into a second cavity with a polished, high-gloss finish, can be provided, for example, before the flooding, potentially also with matted or structured regions.

In this alternative method, the transparent plastic can be a 2K polyurethane system having an inner separating agent, or preferably a 2K polyurea system.

Furthermore, in this case, a post-processing step can also follow the deformation of the decorative moulding, which follows the removal of sprues and, additionally or alternatively, in the use of the 2K polyurethane system with an inner separating agent, the removal of the separating agent layer on the surface of the lacquer; for example by polishing.

Furthermore, in this method, a final assembly stage can be implemented, in which the decorative moulding is assembled into a superior component, for example a framework.

These and other advantages are demonstrated by the description below with reference to the accompanying FIGURE. The reference to the FIGURE in the description serves to support the description and to facilitate understanding of the subject matter.

The FIGURE is merely a schematic depiction of one embodiment of the invention and schematically shows the method steps for the production of a decorative moulding according to the invention in a multi-stage or two-stage process.

The invention relates to decorative mouldings, in particular decorative parts for interior trim in a motor vehicle, for example decorative parts for the instrument panel, the central console and door trim, and to methods for the production of the decorative moulding.

The decorative parts provided for interior trim of motor vehicles such as passenger motor vehicles, which are to fulfill the increasing demand for interior design, are herein produced from polymerous materials, preferably synthetic polymerous materials, and have a high-gloss, free-formed surface and a multilayer structure. The basic body, which, as the lowermost component layer, assumes the thermal, mechanical and security-related functions, can be composed of a light-impermeable or even a transparent or translucent plastic and has a strongly structured surface positioned on the body design of the final component added to it.

The “body design” of a vehicle is understood in the field of automobile manufacturing to be the geometrical representation of all surfaces in the interior and exterior that are visible to the customer, taking into account all technical and formal aesthetic requirements. The body design is therefore the link between design and construction. In the body design, the designed surfaces are reproduced with the desired quality and light effects (reflections, “highlights”) are optimised on the surfaces. Furthermore, in the body design, construction requirements are implemented, for example that the surfaces must be able to be demoulded from a moulding tool and that tool dividing lines must not, as far as possible, lie on the visible surface.

The structure of this surface provided as the visible side of the decorative moulding is either particularly emphasised by flake-like effect pigments introduced into the basic body, and/or an intermediate layer made from polymerous material having flake-like effect pigments are configured or positioned as parallel as possible to the component surface. Furthermore, a clear or transparent, coloured cover layer made from a polymer material that can be applied with a layer thickness of from 0.15 to 3 mm, gives the composite the desired surface properties with respect to scratch resistance and media resistance, and, in particular due to its light-diffracting properties, serves to reinforce the surface structure of the layer located thereunder with effect pigments added to it.

Such decorative parts having a tool-embossed surface can, for example, be produced by means of 2K thermoplastic techniques. The transparent cover layer can be produced by overmoulding or injection compression with cellulose acetate (CA), methacrylic acid butadiene 1,3-styrene terpolymer (MABS), acrylic acid styrene acrylonitrile terpolymer (ASA), polycarbonate (PC), in particular poly(methyl methacrylate) (PMMA).

Alternatively to this, a practically “pressureless”, reactive 2K flooding process can be used with plastics from isocyanate chemistry for the production of the decorative parts with a tool-embossed surface, wherein it is to be ensured that the temperature of the inflowing reaction mixture for the formation of the cover layer is between 50 and 90° C. in order not to damage or melt the filigree edges of the thermoplastic surface of the basic body.

In this variant, for the formation of the cover layer, provision can be made to flood the basic body with clear or highly-transparent, coloured reaction mixtures on its structured surface that forms the visible side, which consist of
oligo ester polyols having 3 to 5 OH groups per molecule, preferably having 3 OH groups per molecule, preferably primary OH groups,
low-molecular chain extenders, such as ethanediol-1,2; bis-(1-hydroxyethyl)-ether; 2,3-propanediol, 1,4-butanediol; 1,6-hexanediol, 2,2′-dimethyl propanediol; isomer mixtures of trimethyl-1,6-hexanediol or isophorone-diol (5-hydroxy-1-hydroxymethyl-1,3,3-trimethylcyclohexane), as well as
oligomeric aliphatic and/or cycloaliphatic polyisocyanates having 2 to 6 NCO groups per molecule, preferably 3 to 4 NCO groups per molecule.

Furthermore, the flooding with clear or highly-transparent, coloured reaction mixtures made from
oligo ester polyols having 3 to 5 OH groups per molecule, preferably having 3 OH groups per molecule, preferably primary OH groups,
low-molecular chain extenders, such as ethanediol-1,2; bis-(1-hydroxyethyl)-ether; 2,3-propanediol, 1,4-butanediol; 1,6-hexanediol, 2,2′-dimethyl 2,3-propanediol; isomer mixtures of trimethyl-1,6-hexanediol or isophorone-diol (5-hydroxy-1-hydroxymethyl-1,3,3-trimethylcyclohexane), as well as
oligomeric aliphatic and/or cycloaliphatic polyisocyanates having 2 to 6 NCO groups per molecule, is possible.

A further possibility consists in flooding with clear or highly-transparent, coloured reaction mixtures made from
oligomeric polyamines; here, oligo ether polyamines, having 3 to 5 NHR′ groups per molecule, are particularly suitable, wherein R′ preferably also represents a hydrogen atom, or made from
low-molecular amine chain extenders, such as ethylene diamine, propylene diamine, tetramethylene diamine, hexamethylene diamine, isomer mixtures of trimethyl-hexanediamine-1,6; isophorone diamine (5-amino-1-aminomethyl-1,3,3-trimethylcyclohexane), as well as oligomeric aliphatic and/or cycloaliphatic polyisocyanates having 2 to 6 NCO groups per molecule.

The mouldings or decorative parts according to the invention having a tool-embossed surface can furthermore be produced by means of a three-layer structure that is produced in multiple stages. To that end, the basic body is injection moulded from a known temperature-resistant plastic and is coated in a further step with an effect lacquer in such a way that the flake-like pigments of the effect lacquer, e.g. metallic pigments and/or the pearlescent pigments, are adapted to the specific structure of the plastic surface, such that the flip-flop effect of the effect pigments emphasises the depth of the structure particularly well at different angles of illumination.

The basic body that is coated with the effect lacquer on the structured visible surface is coated with a transparent polymerous cover layer in a further step in such a way that, on the one hand, a glossy surface arises, which, on the other hand, further reinforces the surface structure of the basic body with its light-diffracting properties, and thus produces an improved 3D or depth effect. The cover layer can, in the variant having the effect pigment produced in the injection moulding process, be produced from a highly-transparent, scratch-proof thermoplastic, such as CA, MABS, ASA, PC, in particular PMMA, and also by injection moulding or injection compression.

As an alternative to this, the transparent cover layer can be produced from reaction products of oligomeric polyamines by means of RIM technology. Oligo ether polyamines, having 3 to 5 NHR′ groups per molecule are particularly suitable, wherein R′ preferably also represents a hydrogen atom; or can be produced from
low-molecular amine, preferably aliphatic or cycloaliphatic, chain extenders, such as ethylene diamine, propylene diamine, tetramethylene diamine, hexamethylene diamine, isomer mixtures of trimethyl-hexanediamine-1,6; isophorone diamine (5-amino-1-aminomethyl-1,3,3-trimethylcyclohexane), as well as oligomeric aliphatic and/or cycloaliphatic polyisocyanates having 2 to 6 NCO groups per molecule, in a tool having a high-gloss surface, preferably without applying separating agents and catalysts.

The coating of the basic body with a transparent polymerous cover layer can be carried out by means of RIM technology from reaction products made from oligo ester polyols having 3 to 5 OH groups per molecule, preferably having 3 OH groups per molecule, preferably primary OH groups, low-molecular chain extenders, such as ethanediol-1,2; 2,3-propanediol, 1,4-butanediol; 1,6-hexanediol, 2,2′-dimethyl propanediol; isomer mixtures of trimethyl-1,6-hexanediol as well as oligomeric aliphatic and/or cycloaliphatic polyisocyanates having 2 to 6 NCO groups per molecule, preferably by applying so-called internal or inner separating agents in a tool having a high-gloss surface.

A cover layer made from reaction products made from oligo ether polyols having 3 to 5 OH groups per molecule, preferably having 3 OH groups per molecule, preferably primary OH groups, low-molecular chain extenders, such as ethanediol-1,2; 2,3-propanediol, 1,4-butanediol; 1,6-hexanediol, 2,2′-dimethyl propanediol; isomer mixtures of trimethyl-1,6-hexanediol as well as oligomeric aliphatic and/or cycloaliphatic polyisocyanates having 2 to 6 NCO groups per molecule, can also be produced by means of RIM technology in a tool having a high-gloss surface, preferably by applying so-called internal separating agents.

Methods and a layer structure are described below for the production of tinted-glass-esque optics of the decorative moulding having a tool-embossed surface by means of the practically “pressureless”, reactive 2K flooding process with plastics from isocyanate chemistry.

Here, an opaque white, brightly coloured or pearlescent basic body having transparent, black-grey-tinted reaction mixtures made from,
oligo ether polyols having 3 to 5 OH groups per molecule, preferably having 3 OH groups per molecule, preferably primary OH groups, the low-molecular chain extenders, as well as the oligomeric aliphatic and/or cycloaliphatic polyisocyanates having 2 to 6 NCO groups per molecule, or
oligo ester polyols having 3 to 5 OH groups per molecule, preferably having 3 OH groups per molecule, preferably primary OH groups, the low-molecular chain extenders, as well as the oligomeric aliphatic and/or cycloaliphatic polyisocyanates having 2 to 6 NCO groups per molecule, or
oligomeric polyamines, preferably oligo ether polyamines, having 3 to 5 NHR′ groups per molecule, wherein R′ preferably also represents a hydrogen atom, the low-molecular amine chain extenders, as well as the oligomeric aliphatic and/or cycloaliphatic polyisocyanates having 2 to 6 NCO groups per molecule,
   floods in order to achieve the tinted-glass-esque optics.

Classical methods for the production of decorative parts or decorative mouldings comprise, in a multi-stage process, the injection moulding of the carrier layer/basic body or the back injection of a decorative film or of a real wood veneer, which is potentially followed by cutting, whereupon either spray painting with a reactive lacquer system, drying, polishing (multiple times or overspraying or flooding) or flooding with a solvent-free 2K polyurethane system follows in a corresponding tool (ClearCoat Molding, classical multi-stage PUR process). During the flooding, after the application of separating agent to the visible tool surface of the flowing tool, the curing and, if necessary, the polishing of the separating agent film in this tool half, the basic body is inserted into the underside of the flowing tool and is flooded with a solvent-free 2K polyurethane system. After the curing of the cover layer in the tool, wherein the tool-embossed surface layer arises, the decorative moulding can be demoulded and the separating agent layer present on the surface of the lacquer can, for example, be removed by polishing. What follows is the cutting of the decorative moulding and, if necessary, the final assembly with a framework.

In a method according to the invention, both in the multi-stage and single-stage process variants, as can be seen in the FIGURE, first the decorative moulding basic body having a deep, three-dimensionally embossed surface that is inclined towards the body design of the decorative moulding is injection moulded with a transparent or translucent plastic, and, in the single-stage processes, which follow the right-hand branch in the FIGURE, is injection moulded with flake-like, reflective effect pigments and, if necessary, further transparent coloured pigments, at least in one layer on the structured surface.

In the multi-stage processes with at least two stages, which follow the left-hand branch in the FIGURE, the effect pigments can potentially be dispensed with during the injection moulding and light-impermeable plastics can be used for the basic body, since here, in the second step, the application of an effect lacquer that is coloured analogously to the thermoplastic of the basic body, which then contains the flake-like effect pigments, follows the injection moulded basic body, such that the surface structure of the basic body protrudes considerably. After the drying of the effect lacquer layer, the basic body is, in the multi-stage processes, inserted into another tool—a flowing tool. In the flowing too, at least the effect-lacquered surface is coated with a highly-transparent cover layer, in that the basic body is either flooded with a relatively thick, solvent-free 2K polyurea system or is overmoulded with a highly-transparent thermoplastic, such as PMMA, amorphous TPU or microcrystalline PA, or preferably undergoes injection compression.

After the curing of the cover layer, the tool-embossed surface is obtained with particular accentuation of the surface structure. The decorative moulding can be demoulded. Post-processing that is potentially to be carried out, such as the removal of sprues, can then take place and, if provided, the decorative moulding can undergo final assembly, for example with a framework.

In the single-stage processes, which follow the right-hand branch in the FIGURE, the injection moulding tool is opened, after the completed injection moulding of the basic body, with a deep, three-dimensionally embossed surface that is inclined towards the body design of the decorative moulding, with a transparent or translucent plastic having incorporated flake-like, reflective effect pigments and, if necessary, further transparent coloured pigments, wherein the basic body remains in the ejector-side tool half. The ejector-side tool half with the basic body is arranged on a second, nozzle-side tool half of the tool by means of a slide table, rotary table or turning plate or similar, said tool half providing a cavity for the creation of the cover layer on the structured visible surface and having a polished, high-gloss surface added to it, as well as, if necessary, matted or structured regions. After the closing of the tool halves, the basic body is now flooded either with a relatively thick, solvent-free 2K polyurea system or with a solvent-free 2K polyurethane system having an inner separating agent, such that, after the curing of the lacquer in the tool, the tool-embossed surface of the decorative moulding is obtained with specific accentuation of the surface structure. After the demoulding of the decorative moulding, the decorative moulding can be post-processed, as in the multi-stage processes, and, for example, sprues can be removed and transferred to the final assembly.

In the method variant that uses the 2K polyurethane system with an inner separating agent for flooding, the removal of the separating agent layer on the surface of the lacquer after the demoulding, for example by polishing, is, if necessary, required as a further post-processing step.

In the prior art, the combined reaction and coating methods described in the single-stage processes, for example the SkinForm® method by Krauss-Maffei, Munich, or DirectSkinning (Bayer, Leverkusen), are known. Here, the injection moulding and coating of the component take place to create a plastic component with leather-like optics in a tool in which the injection moulded support component remains on the closing-side mould core and is coated after being transferred into a second cavity to which a PUR mixing head is applied. Further methods and tools for “lacquering in a closed tool” are ColorForm by Krauss-Maffei or Directcoating by Bayer. Also, the method known as puroskin™ Ruhl, Friedrichsdorf, Germany, combines the injection moulding and reaction techniques in a single process. Furthermore, with the clearmelt method, the flooding of a thermoplastic support component with transparent polyurethane by means of slide table technology is known from ENGEL (Schwertberg, Austria), as well as a method known as x-melt, which is high-speed injection moulding wherein the compressibility of the plastic melt is used as an energy store

However, only PUR systems (polyol and polyisocyanate) have been used to date for the production of the coating in the known, combined reaction and coating methods.

Here, due to the low level of reactivity, relatively large amounts of catalyst are required, which have a negative impact on ageing behaviour. The OH groups have a similar level of reactivity to water, such that, without a separating agent, it leads to urea deposition on the tool surfaces.

Due to their high level of reactivity, the polyurea (PU) systems (polyisocyanate and polyamine) used in an embodiment according to the invention advantageously do not require any catalysts, such that they display improved ageing behaviour. Furthermore, no constantly renewed separating agents are required due to the high reactivity.

1-15. (canceled)

16. A decorative moulding comprising
at least one injection moulded basic body made from thermoplastic material having a deep 3D surface structure on a visible surface and
a cover layer made from transparent plastic that is applied at least to the visible surface,
wherein the basic body has at least one layer, which contains flake-like effect pigments, on the visible surface, wherein the flake-like effect pigments exist with predominantly parallel positioning with respect to the surface of the visible surface of the basic body, and wherein the plastic that forms the basic body contains the flake-like effect pigments.

17. The decorative moulding according to claim 16, wherein the thermoplastic material of the basic body is a transparent, translucent or opaque, coloured or colourless plastic.

18. The decorative moulding according to claim 16, wherein the decorative layer is coloured or colourlessly transparent and comprises
at least one thermoplastic, comprising cellulose acetate (CA), methacrylic acid butadiene 1,3-styrene terpolymer (MABS), acrylic acid styrene acrylonitrile terpolymer (ASA), polycarbonate (PC), poly(methyl methacrylate) (PMMA), amorphous TPU, microcrystalline PA,
a 2K polyurethane system, a 2K polyurethane system with integrated separating agents, made from oligoether polyols having 3 to 5 OH groups per molecule, low-molecular chain extenders selected from the group consisting of ethanediol-1,2; bis-(1-hydroxyethyl)-ether; 2,3-propanediol, 1,4-butanediol; 1,6-hexanediol, 2,2′-dimethylpropanediol; isomer mixtures of trimethyl-1,6-hexanediol or 5-hydroxy-1-hydroxymethyl-1,3,3-trimethylcyclohexane (isophorone-diol), as well as oligomeric aliphatic and/or cycloaliphatic polyisocyanates having 2 to 6 NCO groups per molecule,
or comprises
oligo ester polyols having 3 to 5 OH groups per molecule, low-molecular chain extenders from the group comprising ethanediol-1,2; bis-(1-hydroxyethyl)-ether; 2,3-propanediol, 1,4-butanediol; 1,6-hexanediol, 2,2′-dimethyl 2,3-propanediol; isomer mixtures of trimethyl-1,6-hexanediol or 5-hydroxy-1-hydroxymethyl-1,3,3-trimethylcyclohexane, as well as oligomeric aliphatic and/or cycloaliphatic polyisocyanates having 2 to 6 NCO groups per molecule, or
a 2K polyurea system made from oligo ether polyamines having 3 to 5 NHR′ groups per molecule, wherein R′ is hydrogen, low-molecular amine chain extenders, aliphatic or cycloaliphatic chain extenders from the group comprising ethylene diamine, propylene diamine, tetramethylene diamine, hexamethylene diamine, isomer mixtures of trimethyl hexane diamine-1,6,5-amino-1-amino methyl-1,3,3-trimethylcyclohexane as well as oligomeric aliphatic and/or cycloaliphatic polyisocyanates having 2 to 5 NCO groups per molecule.

19. The decorative moulding according to claim 16, wherein the basic body is coloured opaque white, brightly coloured or pearlescent and the cover layer is transparent black-grey, wherein a tinted-glass-esque surface appearance of the visible surface of the decorative moulding is provided.

20. The decorative moulding comprising at least one injection moulded basic body made from thermoplastic material having a deep 3D surface structure on a visible surface and a cover layer made from transparent plastic that is applied at least to the visible surface, wherein the basic body has at least one layer on the visible surface, wherein the layer, which is a supplemental polymer layer applied to the basic body, contains flake-like effect pigments, which exist with predominantly parallel positioning with respect to the surface of the visible surface of the basic body, wherein the cover layer consists of a 2K polyurea system.

21. The decorative moulding according to claim 20, wherein the basic body contains or does not contain flake-like effect pigments

22. The decorative moulding according to claim 20, wherein the thermoplastic material of the basic body is a transparent, translucent or opaque, coloured or colourless plastic.

23. The decorative moulding according to claim 21, wherein the polymerous material of the layer containing the flake-like effect pigments corresponds to the plastic of the basic body, wherein the polymerous material is transparent, translucent or opaque and is coloured or colourless according to the plastic of the basic body.

24. The decorative moulding according to claim 20, wherein the cover layer is coloured or colourlessly transparent and the 2K polyurea system of the cover comprises oligomeric polyamines having 3 to 5 NHR′ groups per molecule, wherein R′ is hydrogen, low-molecular amine chain extenders, aliphatic or cycloaliphatic chain extenders from the group consisting of ethylene diamine, propylene diamine, tetramethylene diamine, hexamethylene diamine, isomer mixtures of trimethyl hexane diamine-1,6, 5-amino-1-amino methyl-1,3,3-trimethylcyclohexane as well as oligomeric aliphatic and/or cycloaliphatic polyisocyanates having 2 to 6 NCO groups per molecule.

25. The decorative moulding according to claim 20, wherein the basic body is coloured opaque white, brightly coloured or pearlescent and the cover layer is transparent black-grey, wherein a tinted-glass-esque surface appearance of the visible surface of the decorative moulding is provided.

26. A method for the production of a decorative moulding, comprising the steps:
injection moulding a basic body from a thermoplastic material in a moulding tool, then forming a deep 3D surface structure on the visible surface provided,
applying a colourless or coloured effect lacquer, which contains flake-like effect pigments that are arranged predominantly parallel with respect to the surface of visible surface of the basic body,
drying the effect lacquer layer,
inserting the basic body with the applied and cross-linked effect lacquer into a flowing tool and applying a transparent plastic at least to the effect-lacquered visible side by flooding with a transparent 2K polyurea system, then forming a decorative layer and curing the decorative layer,
and
demoulding the decorative mould.

27. The method according to claim 26, wherein
a post-processing step comprising the removal of sprues, and/or
a final assembly step of the decorative moulding follows the demoulding of the decorative moulding

28. The method for the production of a decorative moulding according to claim 26, comprising the steps:
injection moulding the basic body from a thermoplastic material, which contains flake-like effect pigments, in a moulding tool with tool halves on the ejector side and the nozzle side, then forming a deep 3D surface structure and positioning the flake-like effect pigments predominantly parallel with respect to a provided visible surface,
opening the moulding tool, wherein the basic body remains in the ejector-side tool half, and arranging this into a second nozzle-side tool half of the moulding tool, which has a cavity for the creation of the decorative layer on the basic body that has a surface added for the surface finish provided,
flooding the visible surface with the surface structure of the basic body with a transparent plastic for the formation of a decorative layer and curing the decorative layer,
demoulding the decorative moulding.

29. The method according to claim 28,
wherein the transparent plastic is a 2K polyurea system or a 2K polyurethane system for an inner separating agent, and wherein
a post-processing step comprising the removal of sprues, and/or
in the case of the use of the 2K polyurethane system with the inner separating agent, carrying out a post-processing step comprising the removal of a separating agent layer on the surface of the lacquer, preferably by polishing,
a final assembly stage of the decorative moulding follows the demoulding of the decorative moulding.

30. The decorative moulding according to claim 18, wherein
the 2K polyurethane system or a 2K polyurethane system with integrated separating agents is made from oligoether polyols having 3 OH groups per molecule, wherein the —OH groups are primary OH groups,
the oligomeric aliphatic and/or cycloaliphatic polyisocyanates have 3 to 4 NCO groups per molecule, and
the oligo ester polyols polyols have 3 OH groups per molecule, wherein the —OH groups are primary OH groups.

31. The method according to claim 27, wherein the final assembly step of the decorative moulding occurs in a framework.

32. The method according to claim 29,
further comprising in the case of the use of the 2K polyurethane system with the inner separating agent, a post-processing step comprising the removal of a separating agent layer on the surface of the lacquer by polishing.

33. The method according to claim 29, wherein the final assembly step of the decorative moulding occurs in a framework.
